(19) United States
(12) Patent Application Publication
(10) Pub. No.: US 2018/0231099 A1
(43) Pub. Date: Aug. 16, 2018

(54) VISCOUS DAMPER

(71) Applicant: Fukoku Co., Ltd., Ageo-shi, Saitama (JP)

(72) Inventor: Shigeyuki Matsumoto, Ageo-shi, Saitama (JP)

(21) Appl. No.: 15/749,992

(22) PCT Filed: Aug. 3, 2016
(86) PCT No.: PCT/JP2016/072849

§ 371 Date: Feb. 2, 2018

(30) Foreign Application Priority Data
Aug. 6, 2015 (JP) 2015-156003

(51) Int. Cl. F16F 15/173; F16F 9/36; F16F 15/16

(52) U.S. Cl. CPC F16F 15/173; F16F 9/36; F16F 15/165; F16F 2222/08; F16F 2234/02; F16F 2236/08; F16F 2230/30; F16F 2222/12

(57) ABSTRACT

A viscous damper 10 has a hub plate 11 mounted on a rotation axis, the hub plate 11 is provided with a cylinder portion 12 protruding axially, and the flange 14 protrudes radially outward from the cylinder portion. An inertia mass body 20 arranged outside the flange 14 includes a first annular inertia member 21 and a second annular inertia member 22, and a journal bearing 20 is arranged between the inertia mass body 20 and the flange 14. An inner periphery portion of the first annular inertia member 21 is provided with a first slid seal 41 for sealing damping liquid, and an inner periphery portion of the second annular inertia member 22 is provided with a second slid seal 42 for sealing the damping liquid L.

### CROSS-REFERENCE TO RELATED APPLICATIONS

This application is a National Stage application of International Patent Application No. PCT/JP2016/072849, filed on Aug. 3, 2016, which claims priority to Japanese Patent Application Number 2015-156003, filed on Aug. 6, 2015, each of which is hereby incorporated by reference in its entirety.

### TECHNICAL FIELD

The present invention relates to a viscous damper that is attached to a rotation axis such as a crank shaft in an internal combustion engine and absorbs torsional vibration of the rotation axis.

### BACKGROUND ART

Each of internal combustion engines, i.e., engines used in a power source of a vehicle such as a car, a truck, and a bus and a power source of an industrial machine such as a construction machine and an agricultural machine has a rotation axis such as a crank shaft and a camshaft. Torsional vibration, i.e., rotational pulsation occurs on the rotation axis due to combustion of fuel. A torsional damper is mounted on the rotation axis in order to absorb this torsional vibration. There is a viscous damper referred to as one type of torsional damper. The viscous damper has a hub-side member mounted on a rotation axis, and an inertia mass body rotatably mounted on an outer periphery portion of the hub-side member, thereby using a shear resistance of damping liquid arranged between the hub-side member and the inertia mass body to absorb and dissipate the torsional vibration of the rotation axis.

Included in the viscous damper are a type of in which the inertia mass body, i.e., an inertia mass is accommodated in an annular case provided to the outer periphery portion of the hub-side member, namely, an inner mass type, and a type in which the inertia mass is mounted so as to surround the hub-side member, i.e., an outside of an outer periphery portion of the hub plate, namely, an outer mass type. Japanese Utility-Model Application Laid-open No. H4-75259 discloses an inner mass type viscous damper in which silicone oil is enclosed, as damping liquid, in a case accommodating an inertia ring serving as the inertia mass. Regarding the inner mass type as disclosed in Japanese Utility-Model Application Laid-open No. H4-75259, the inertia mass is accommodated in the case, so that size and form of the inertia mass cannot be easily altered in conformity with an object which absorbs the torsional vibration. Further, since the inertia mass needs to be covered with the case, mass of an anti-vibration system including the hub-side member becomes large, and a mass ratio with the inertia mass cannot be increased.

Each of Japanese Utility-Model No. H3-2033; Japanese Patent No. S42-12872; Japanese Patent No. S39-14885; Japanese Utility-Model Application Laid-open No. S51-110190; and Japanese Patent No. S44-29494 discloses an outer mass type viscous damper. In the viscous damper disclosed in Japanese Utility-Model No. H3-2033, vibration rings as inertia masses are mounted on both sides of an outer periphery portion of a plate-shaped hub-side member, and annular rubber is sandwiched and inserted between each of the vibration rings and the hub-side member. Meanwhile, in the viscous damper disclosed in each of Japanese Patent No. S42-12872; Japanese Patent No. S39-14885; Japanese Utility-Model Application Laid-open No. S51-110190; and Japanese Patent No. S44-29494, a cylinder portion is provided to an outer periphery portion of a hub-side member; a flange extending radially outward is provided to the cylinder portion; and an annular inertia mass body is mounted outside the flange. In order to seal damping liquid enclosed in a space between the flange and the inertia mass body, the viscous damper disclosed in Japanese Utility-Model No. H3-2033 has an elastic band(s) press-fitted between an inner periphery surface of the inertia mass body and the cylinder portion, and the viscous damper disclosed in Japanese Patent No. S39-14885 has an O-ring(s) to be press-fitted. Further, each of the viscous dampers disclosed in Japanese Utility-Model Application Laid-open No. S51-110190 and Japanese Patent No. S44-29494 has an elastic member(s) press-fitted into corner portions of the flange and the cylinder portion.

### SUMMARY

In the outer mass type viscous damper as described above, the inertia mass operated by vibration is mounted outside the outer periphery portion of the hub-side member, so that an elastic member for seal to be mounted between the inertia mass and the hub-side member needs to be assembled so as to become a pressurized state in terms of prevention of leakage of the damping liquid from between the inertia mass and the hub-side member. However, if the elastic member for seal to be mounted between the inertia mass and the hub-side member in order to prevent such leakage has a great contact force, the inertia mass cannot be greatly displaced with respect to the hub-side member and a great shear force cannot be applied to the damping liquid enclosed between the hub-side member and the inertia mass, so that great vibration attenuation due to the shear resistance of the damping liquid cannot be expected. Additionally, if the elastic member for seal has a high pressurization force, a press-fitting resistance of the elastic member for seal becomes high, and the outer mass type viscous damper becomes difficult to assemble. For this reason, if the contact force of the elastic member for seal is weakened for permitting slipping, a holding force of the inertia mass due to the elastic member becomes weak, so that the inertia mass irregularly swings greatly during the vibration, and there is a possibility that deterioration in local abrasion and/or vibration damping of the elastic member for seal will occur.

An object of the present invention is to provide a viscous damper having high vibration damping. Further, another object thereof is to provide the viscous damper that is easily assembled and in which it is difficult for a slid seal(s) to peel off and fall and/or abrade even if the viscous damper is used over a long period of time.

A viscous damper according to the present invention comprises: a hub plate having a plate base and a flange, a cylinder portion protruding axially and being provided to an outer periphery portion of the plate base, the flange protruding radially outward from the cylinder portion; an inertia mass body having a first annular inertia member and a second annular inertia member and arranged via a space outside the flange, the first annular inertia member being provided with a first opposite surface opposing one surface of the flange, the second annular inertia member being provided with a second opposite surface opposing the other surface of the flange; a journal bearing arranged between a support surface provided to the inertia mass body and an outer periphery surface of the flange; a first slid seal provided into an inner periphery portion of the first annular inertia member and sealing damping liquid with which an inside of the space present between the first annular inertia member and the cylinder portion is filled; and a second slid seal provided into an inner periphery portion of the second annular inertia member and sealing damping liquid with which an inside of the space present between the second annular inertia member and the cylinder portion is filled.

According to a viscous damper of the present invention, each of the slid seals permits a great differential of the inertia mass body with respect to the hub plate to realize high vibration-proof properties, and no displacement other than a rotation-directional displacement of the hub plate occurs on the inertia mass body. Additionally, since no radial load from the inertia mass body is applied to the slid seals, abrasion of the slid seals is suppressed. Therefore, durability of the viscous damper can be improved with vibration-proof properties of the viscous damper maintained.

### BRIEF DESCRIPTIONS OF THE DRAWINGS

FIG. 1 is a sectional view of a viscous damper according to an embodiment;

FIG. 2 is a right side view of FIG. 1;

FIG. 3 is an enlarged sectional view of a principal part of FIG. 1;

FIG. 4 is a sectional view showing a principal part of a viscous damper according to another embodiment; and

FIG. 5 is a sectional view showing a principal part of a viscous damper according to yet another embodiment.

### DETAILED DESCRIPTION

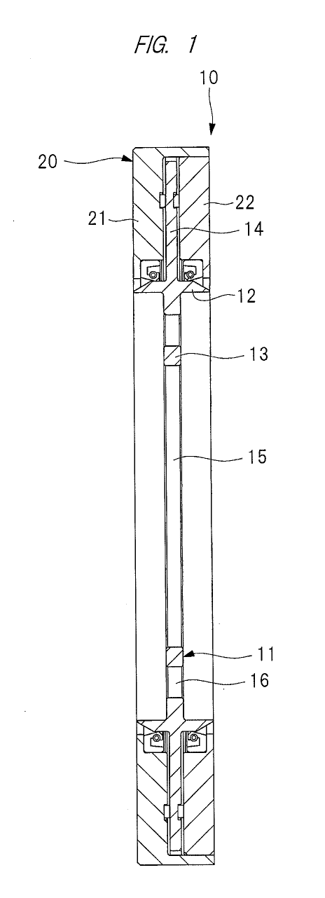

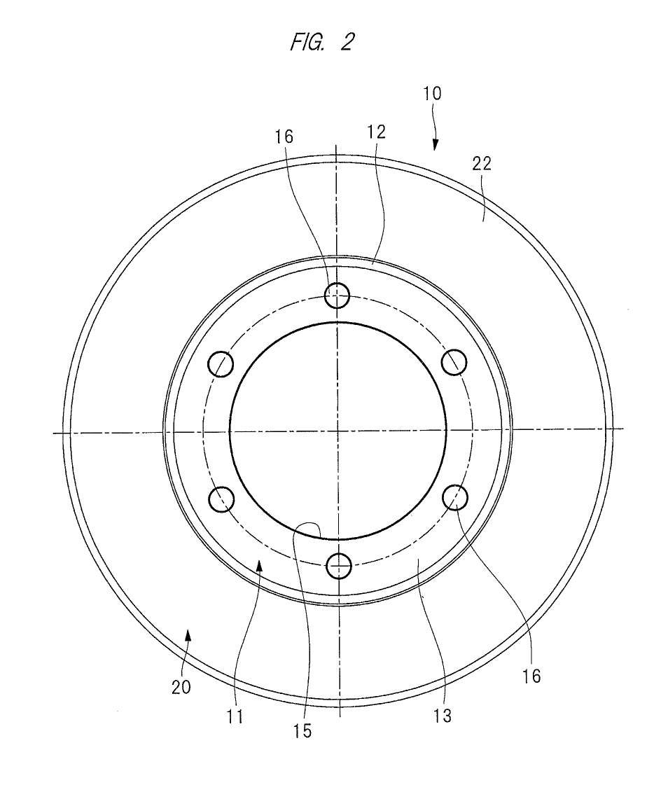

Hereinafter, an embodiment according to the present invention will be detailed based on the accompanying drawings. A viscous damper 10 shown in FIGS. 1 and 2 has a disk-shaped hub-side member, i.e., a hub plate 11. The hub plate 11 is mounted on a not-shown rotation axis such as a crank shaft and a camshaft in an engine used as a power source of a vehicle such a car, a truck, and a bus or/and a power source of an industrial machine such as a construction machine. The hub plate 11 has a plate base 13 whose outer periphery portion is provided integrally with a cylinder portion 12. The cylinder portion 12 protrudes axially from both surfaces of the plate base 13. A flange 14 protrudes radially outward from an axial middle part of the cylinder portion 12, and the flange 14 becomes integrated with the cylinder portion 12.

The hub plate 11 is provided with: a through-hole 15 into which the rotation axis is inserted; and a plurality of attachment holes 16 into which not-shown bolts are inserted, and the hub plate 11 is attached to the rotation axis by the bolts.

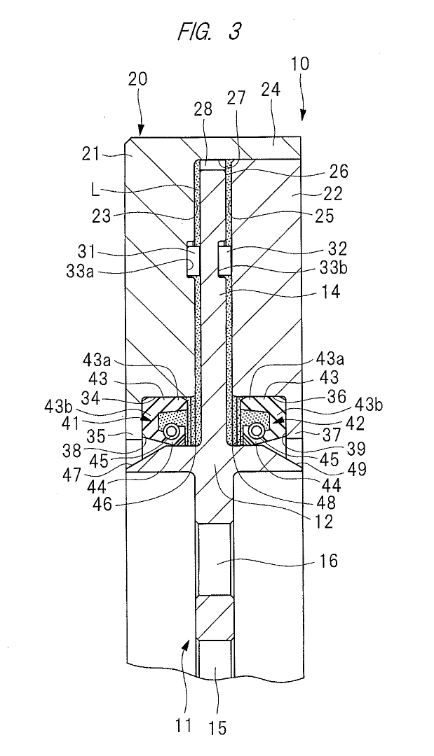

An inertia mass, i.e., an inertia mass body 12 is arranged outside the flange 14, and the viscous damper 10 is an outer mass type in which the inertia mass is mounted outside the flange 14. The inertial mass body 20 included a first annular inertia member 21 and a second annular inertia member 22, and is assembled by combining the both members. As shown in FIG. 3, the first annular inertia member 21 is provided with a first opposite surface 23 opposing one surface of the flange 14, and a fit part 24 protrudes axially from an outer periphery portion of the annular member 21. The second annular inertia member 22 is provided with a second opposite surface 25 opposing the other surface of the flange 14, and is press-fitted into the fit part 24 of the first annular inertia member 22.

An interval between the both opposite surfaces 23 and 25 is set larger than a thickness of the flange 14. A space 26 is formed between the flange 14 and each of the opposite surfaces 23 and 25, and silicon oil is enclosed, as damping liquid, in the space 26. The space 26 between the flange 14 and the inertia mass body 20 becomes a narrow space, so that torsional vibration of the rotation axis causes a differential to occur between the flange 14 and each of the opposite surfaces 23 and 25. The damping liquid L is subjected to a shear force by this differential, and the torsional vibration is absorbed and dissipated by a shear resistance of the damping liquid.

A surface present on an inner periphery surface of the fit part 24 of the annular inertia member 21 and between the both opposite surfaces 23 and 25 is a support surface 27, and a journal bearing 28 is arranged between this support surface 27 and an outer periphery surface of the flange 14. Therefore, a load radially applied to the hub plate 11 from the inertia mass body 20 is supported via the journal bearing 28 by the hub plate 11, and the inertia mass body 20 is concentrically held by the rotation axis. This prevents the inertia mass body 20 from being made eccentric to the hub plate 11, i.e., the rotation axis.

A first thrust bearing 31 is provided between the flange 14 and the first opposite surface 23, and a second thrust bearing 32 is provided between the flange 14 and the second opposite surface 25. The thrust bearing 31 is incorporated into an accommodation groove 33a annularly provided in the opposite surface 23 of the annular inertia member 21. The thrust bearing 32 is incorporated into an accommodation groove 33b annularly provided in the flange 14. Thus, even if an external force is applied in a direction of slanting the inertia mass body 20, the inertia mass body 20 is supported by the hub plate 11 via the both thrust bearings 31 and 32, and an axial position of the rotation axis is held with the inertia mass body 20.

The journal bearing 28 supports the load radially applied to the hub plate 11, and the two thrust bearings 31 and 32 support the load applied in the direction of slanting the hub plate 11, so that the loads applied to the hub plate 11 are supported by the different bearings. For this reason, the load applied to the journal bearing 28 does not influence the thrust bearings 31 and 32 and, similarly, the load applied to the thrust bearings 31 and 32 does not influence the journal bearing 28, so that durability of each bearing can be improved. Incidentally, the accommodation groove 33b into which the thrust bearing 32 is incorporated may be provided in the opposite surface 25 of the annular inertia member 22. Additionally, both of the thrust bearings 31 and 32 may be provided so as to cause the journal bearing 28 to approach the outer periphery portion of the flange 14. Further, the thrust bearing 32 may be arranged not as an annular shape but as a plurality of circumferentially split shapes.

Incidentally, a viscous damper mounted in a general engine is used in an upright state (a rotation axis is horizontal), and is used in a state where damping liquid L has a filling rate of about 90% in many cases in terms of thermal expansion. For these reasons, the annular thrust bearings 31 and 32 is adopted, so that it is difficult for the damping liquid L to flow downward even at a time of stopping the engine, and some of the damping liquid L is easy to remain in a circumference of the journal bearing 28. Therefore, abrasion of the journal bearing 28 can be prevented.

This viscous damper 10 can be used also as another rotation axis, for example, a pulley for transmitting rotative power to an alternator etc., the pulley being mounted on the rotation axis. In the viscous damper 10 utilized for such use, a pulley groove is provided to the outer periphery portion of the annular inertia member 21, and a pulley belt is hung to and put in the pulley groove. When the pulley belt is hung to and put in the viscous damper, the radial load is applied to the inertia mass body 20. However, since the journal bearing 28 is arranged between the flange 14 and the inertia mass body 20, the load applied to the inertia mass body 20 can be received by the hub plate 11.

A support hole 34 is provided in an inner periphery portion of the annular inertia member 21, and the support hole 34 is opened at a radially inner end of the opposite surface 23 and protrudes axially from this inner end. A first dropout prevention wall 35 protrudes radially inward from the inner periphery portion of the annular inertia member 21 on an outer surface side thereof, and an inner surface of this first dropout prevention wall 35 becomes a bottom surface of the support hole 34. Similarly, a support hole 36 having almost the same inside diameter as that of the support hole 34 is provided to the inner periphery portion of the annular inertia member 22, and the support hole 36 is opened at a radial inner end of the opposite surface 25 and protrudes axially from this inner end. A second dropout prevention wall 37 protrudes radially inward from the inner periphery portion of the annular inertia portion 22 on an outer surface side thereof, and an inner surface of this dropout prevention wall 37 becomes a bottom surface or the support hole 36.

An annular accommodation groove 38 partitioned by the support hole 34 and the dropout prevention wall 35 is opened toward the flange 14 and the cylinder portion 12, and a first slid seal 41 is mounted in the accommodation groove 38. The damping liquid L with which an inside of the space 26 is filled is sealed between the annular inertia member 21 and the cylinder portion 12 by the slid seal 41. Similarly, an annular accommodation groove 39 partitioned by the support hole 36 and the dropout prevention wall 37 is opened toward the flange 14 and the cylinder portion 12, and a second slid seal 42 is mounted in the accommodation groove 39. The damping liquid L with which the inside of the space 26 is filled is sealed between the annular inertia member 22 and the cylinder portion 12 by the slid seal 42.

The slid seal 41 has a main body 43, and the main body 43 includes: an axial part 43a axially protruding and fitted into the support hole 34, and a radial part 43b radially extending from its annular part and striking the dropout prevention wall 35. Since the radial part 43b strikes (buttes) the dropout prevention wall 35, the slid seal 41 is held in the accommodation groove 38 so as not to move axially. The main body 43 of the slid seal 41 is provided integrally with a lip portion 44. The lip portion 44 slants radially inward from a radially inner end portion of the radial part 43b toward the cylinder portion 12, and a tip portion of the lip portion 44 slides over and contacts with a one-side outer periphery surface of the cylinder portion 12. The slid seal 42 has almost the same structure as that of the slid seal 41, and includes a main body 43 and a lip portion 44, and the lip portion 44 slides over and contacts with the other-end outer periphery surface of the cylinder portion 12.

A tensile coil spring 45 serving as a spring member is mounted on the lip portion 44 of each of the slid seals 41 and 42, and a spring force in a direction verging toward the cylinder portion 12 is energized to the lip portion 44 due to the tensile coil spring 45. The tensile coil spring 45 is mounted onto the lip portion 44 from a space between the lip portion 44 and the axial part 43a. The damping liquid L can contact with not only the space between the lip portion 44 and the axial part 43a but also a slid-contact portion between the lip portion 44 and the outer periphery portion of the cylinder portion 12. The damping liquid L contacts with the slid-contact portion, thereby suppressing heat generation of the slid-contact portion during the vibration and making it possible to suppress abrasion.

The one-end outer periphery surface of the cylinder portion 12 has: a first contact surface 46 that extends axially and with which the lip portion 44 of the slid seal 41 contacts; and a first taper surface 47 slanting radially inward from the contact surface 46 toward an end surface of the cylinder portion 12. Similarly, the other-end outer periphery surface of the cylinder portion 12 has: a second contact surface 48 that extends axially and with which the lip portion 44 of the slid seal 42 contacts; and a second taper surface 49 slanting radially inward from the contact surface 48 toward the other end surface of the cylinder portion 12.

Since the load radially applied to the hub plate 11 from the inertia mass body 20 is supported by the hub plate 11 via the journal bearing 28, no load is radially applied to the slid seals 41 and 42 from the inertia mass body 20, and eccentric generation of the inertia mass body 20 is suppressed. Thus, since the slid seals 41 and 42 do not need to hold the radial load, a proper contact force can be applied to the lip portion 44 in order to prevent leakage of the damping liquid L and suppress abrasion of the slid-contact portion. Further, since the lip portion 44 does not need to consider a displacement other than a rotation-directional displacement, durability of the viscous damper 10 can be improved.

As described above, since the taper surfaces 47 and 49 are provided to both axial end portions of the cylinder portion 12, the viscous damper 10 can be easily assembled. That is, when the viscous damper 10 is assembled, the annular inertia member 21 in which the slid seal 41 is inserted into the accommodation groove 38 is installed outside the flange 14. At this time, when the lip portion 44 of the slid seal 41 firstly contacts with the taper surface 47 to cause the annular inertia member 21 to approach the hub plate 11, the lip portion 44 is guided by the taper surface 47 to be elastically deformed radially outward, and reaches a position of contacting with the contact surface 46. Thus, the annular inertia member 21 can be easily installed onto the hub plate 11.

Next, the annular inertia member 22 in which the slid seal 42 is inserted into the accommodation groove 39 is fitted into the fit part 24. At this time, when the lip portion 44 of the slid seal 42 contacts with the taper surface 49 and the annular inertia member 22 approaches the hub plate 11, the lip portion 44 is guided by the taper surface 49 to be elastically deformed radially outward, and reaches a position of contacting with the contact surface 48. Thus, since the taper surfaces 47 and 49 are provided to the cylinder portion 12, the viscous damper 10 can be easily assembled, which makes it possible to improve assembly workability.

Since the slid seal 41 strikes the dropout prevention wall 35 and the slid seal 42 strikes the dropout prevention wall 37, the respective slid seals 41 and 42 are not displaced in assembling the viscous damper 10, which makes it possible to easily assemble the viscous damper 10.

Each lip portion 44 has a form of slid-contacting with the contact surfaces 46 and 48 axially extended. However, the embodiment may have such a configuration that the entire outer periphery surface of the cylinder portion 12 is formed as the taper surfaces 47 and 49 and the lip portion 44 is caused to slid-contact with each of the taper surfaces 47 and 49 formed.

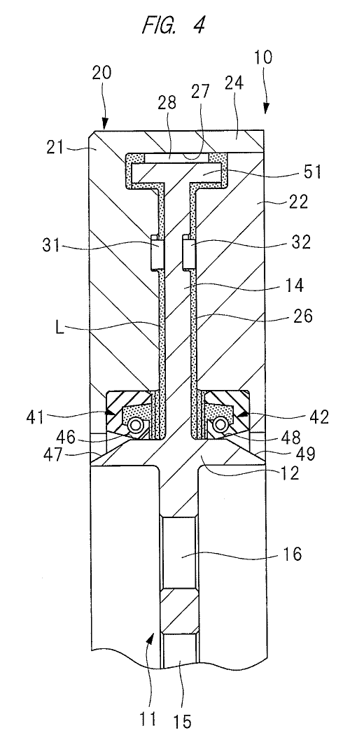

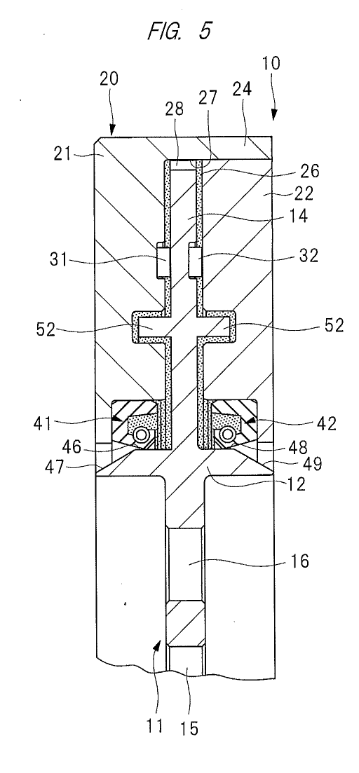

FIGS. 4 and 5 are sectional views each showing a principal portion of a viscous damper according to other embodiment. In FIGS. 4 and 5, members having properties common to the members shown in FIG. 3 are denoted by the same reference numbers as those shown in FIG. 3, and duplicate explanations will be omitted.

In a viscous damper 10 as shown in FIG. 4, an outer periphery cylinder portion 51 axially extended and protruding from both surfaces of the flange 14 is provided to the outer periphery portion of the flange 14. Thus, when the outer periphery cylinder portion 51 is provided to the flange 14, an axial length size of a journal bearing 28 can be made longer than that of the journal bearing 28 shown in FIG. 3. If the journal bearing 28 having a long size can be mounted between the flange 14 and the support surface 27, an effective area for supporting the hub plate 11 due to the journal bearing 28 can be increased. This makes it possible to more certainly prevent a slant of the inertia mass body 20 to the hub plat 11. Further, since shear areas of the opposite surfaces 23 and 25 etc. forming the space 26 can be increased, a shear resistance of the damping liquid L is enhanced, which makes it possible to enhance absorption properties of torsional vibration of the rotation axis. The other structure is almost the same as that of the viscous damper 10 shown in FIG. 3.

As shown in FIG. 4, in the embodiment of providing the outer periphery cylinder portion 51 to the outer periphery portion of the flange 14, a thrust bearing(s) may be mounted between each of both side surfaces of the outer peripheral cylinder portion 51 and each of the inertia mass members 21 and 22.

In a viscous damper 10 shown in FIG. 5, an annular projection portion 52 axially protruding from the both surfaces of the flange 14 is provided to a radial middle portion of the flange 14. The space 26 is formed between the annular projection portion 52 and each of the annular inertia members 21 and 22. Therefore, shear areas of the opposite surfaces 23 and 25 etc. forming the space 26 also in the viscous damper 10 shown in FIG. 5 can be increased larger than that shown in FIG. 3. The other structure is almost the same as that of the viscous damper 10 shown in FIG. 3. Additionally, as shown in FIG. 5, also in the embodiment of providing the annular projection portion 52, a thrust bearing(s) may be mounted between the annular projection portion 52 and each of the annular inertia members 21 and 22. Here, ever if the viscous damper is not filled with the damping liquid L up to 100%, presence of the annular projection portion 52 makes it easy for the damping liquid L to persist on an inside diameter side more than in the annular projection portion 52, and makes it possible to hold the damping liquid L in the slid-contact portion between the lip portion 44 of each of the slid seals 41 and 42 and the cylinder portion 12. Therefore, the damping liquid L functions as a lubricant, and the heat generation and abrasion of the lip portion 44 can be suppressed.

The present invention is not limited to the above embodiments, and can be variously altered and modified within a range not departing from the gist. For example, in addition to use of silicon oil, used as the damping liquid L can be ethylene glycol aqueous solution etc. when damping performance to be required is low. Additionally, in the above embodiments, a fitting method is adopted for assembling the annular inertia members 21 and 22, but can be replaced with an ordinarily known method, for example, a bonding or bolting, etc. method. Further, after removing a disk-shaped part of the plate base 13 in the hub plate 11, the rotation axis can be also fitted in and fixed to an inside diameter side of the cylinder portion 12 directly. Furthermore, in the above embodiments, the tensile coil spring 45 is used, but the tensile coil spring 45 may be done without. In this case, an inside diameter of the fit-contact portion of the lip portion 44 is formed slightly smaller than that of the contact surface 48 of the cylinder portion 12, and the fit-contact portion is installed by the taper surfaces 47 and 49 with its diameter enlarged, which makes it possible to easily assemble the viscous damper.

The viscous damper of this invention is applied for absorbing torsional vibration of a rotation axis such as a crank shaft in an internal combustion engine.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed:

1. A viscous damper comprising:
a hub plate having a plate base and a flange, a cylinder portion protruding axially and being provided to an outer periphery portion of the plate base, the flange protruding radially outward from the cylinder portion;
an inertia mass body having a first annular inertia member and a second annular inertia member and arranged via a space outside the flange, the first annular inertia member being provided with a first opposite surface opposing one surface of the flange, the second annular inertia member being provided with a second opposite surface opposing the other surface of the flange;
a journal bearing arranged between a support surface provided to the inertia mass body and an outer periphery surface of the flange;
a first slid seal provided into an inner periphery portion of the first annular inertia member and sealing damping liquid with which an inside of the space present between the first annular inertia member and the cylinder portion is filled; and
a second slid seal provided into an inner periphery portion of the second annular inertia member and sealing damping liquid with which an inside of the space present between the second annular inertia member and the cylinder portion is filled.

2. The viscous damper according to claim 1,
wherein each of the first slid seal and the second slid seal includes a main body mounted on the inertia mass body, and a lip portion provided integrally with the main body and contacting with the cylinder portion.

3. The viscous damper according to claim 1,
wherein a one-end outer periphery surface of the cylinder portion has a first contact surface that extends axially and with which the first slid seal contacts, and a first taper surface slanting radially inward from the first contact surface toward one end surface of the cylinder portion, and
the other-end outer periphery surface of the cylinder portion has a second contact surface that extends axially and with which the second slid seal contacts, and a second taper surface slanting radially inward from the second contact surface toward the other end surface of the cylinder portion.

4. The viscous damper according to claim 1,
wherein an inner periphery portion of the first annular inertia member is provided with a first dropout prevention wall protruding radially inward and holding the first slid seal, and
an inner periphery portion of the second annular inertia member is provided with a second dropout prevention wall protruding radially inward and holding the second slid seal.

5. The viscous damper according to claim 1,
wherein an outer periphery portion of the flange is provided with an outer periphery cylinder portion that extends axially to protrude from both surfaces of the flange and is supported by the journal bearing.

6. The viscous damper according to claim 1,
wherein a radial middle portion of the flange is provided with an annular projection portion protruding axially from the flange.
